(19) United States
(12) Patent Application Publication
(10) Pub. No.: US 2026/0296468 A1
(43) Pub. Date: Oct. 1, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventors: Nozomu Hirosawa, Tokyo (JP); Takuma Kobayashi, Tokyo (JP)

(21) Appl. No.: 19/550,394

(22) Filed: Feb. 26, 2026

(30) Foreign Application Priority Data
Mar. 28, 2025 (JP) 2025-055534

(51) Int. Cl. B60W 50/12; B60W 10/20

(52) U.S. Cl. CPC B60W 50/12; B60W 10/20; B60W 2540/00; B60W 2710/20; B60W 2720/10

(57) ABSTRACT

A travel control device of an embodiment comprises a recognizer that recognizes a surrounding situation of a vehicle, a detector that detects at least one of an occupant’s state and an occupant’s instruction operation, an action plan generator that generates a action plan of the vehicle, and a travel controller that executes travel control of the vehicle, wherein the action plan generator generates first and second action plans, causes the first action plan to execute travel control based on predetermined behavior control when an activation instruction of the predetermined behavior control is received during travel control by the first action plan, and switches from travel control by the second action plan to travel control by the first action plan to execute travel control based on the predetermined behavior control when the activation instruction of the predetermined behavior control is received during travel control by the second action plan.

### CROSS-REFERENCE TO RELATED APPLICATION

This application claims priority based on Japanese Patent Application No. 2025-055534 filed on Mar. 28, 2025, the contents of which are incorporated herein by reference.

### BACKGROUND

### FIELD OF THE INVENTION

The present invention relates to a travel control device, a travel control method, and a storage medium.

### DESCRIPTION OF RELATED ART

In recent years, efforts to provide access to sustainable transportation systems that consider vulnerable people among traffic participants have been intensified. Toward this realization, research and development are being focused on further improving traffic safety and convenience through research and development related to automated driving technology. Related to this, conventionally, there are known a technology that receives information indicating a plurality of action plans from a plurality of systems and preferentially selects an action plan set by one of the systems, and a technology that controls a vehicle to have a safe state according to an automated driving level when a determination result is obtained from driver vital data that the driver is experiencing a physical abnormality (for example, Japanese Patent Laid-Open No. 2024-091663 and International Publication No. WO 2020-100584).

### SUMMARY

Incidentally, in automated driving technology, although there are individual disclosures regarding prioritizing one of a plurality of systems conventionally and control at the time of a driver's physical abnormality, specific consideration has not been given to which system among the plurality of systems should be used and how to control when a physical abnormality occurs. Therefore, if the driver is in a state not suitable for driving (abnormal state), since the system being executed performs control when the driver is in an abnormal state, it becomes necessary to incorporate control content for the abnormal state into all of the plurality of systems in advance, which may result in redundant systems and enormous data capacity. Moreover, depending on the characteristics of the system, travel control when the driver becomes in an abnormal state may become difficult. Thus, conventionally, there has been a problem that appropriate travel control may not be possible when the driver is in a state not suitable for driving.

In order to solve the above problem, one object of the present application is to provide a travel control device, a travel control method, and a storage medium capable of executing more appropriate travel control even when the driver is in a state not suitable for driving. This in turn will contribute to the development of sustainable transportation systems.

The travel control device, travel control method, and storage medium according to this invention adopt the following configurations.
(1): A travel control device according to one aspect of this invention comprises: a recognizer that recognizes a surrounding situation of a vehicle; a detector that detects at least one of a state of an occupant of the vehicle and an instruction operation by the occupant; an action plan generator that generates an action plan of the vehicle based on a recognition result by the recognizer and a detection result by the detector; and a travel controller that controls at least one of steering and speed of the vehicle to execute travel control of the vehicle based on the action plan generated by the action plan generator, wherein the action plan generator comprises: a first action plan generator that generates a first action plan based on a preset rule; and a second action plan generator that generates a second action plan based on a model learned to generate an action plan based on external world information, and the action plan generator causes the travel controller to execute predetermined behavior control for the vehicle in response to the state of the occupant or an operation instruction of the occupant even in a case where travel control of either the first action plan or the second action plan is being executed by the travel controller, causes the first action plan to execute travel control based on the predetermined behavior control when an activation instruction of the predetermined behavior control is received during travel control by the first action plan, and switches from travel control by the second action plan to travel control by the first action plan to execute travel control based on the predetermined behavior control when the activation instruction of the predetermined behavior control is received during travel control by the second action plan.
(2): In the aspect of (1) above, the action plan generator causes the travel controller to execute travel control by switching stepwise from the second action plan to the first action plan when the activation instruction of the predetermined behavior control is received during travel control by the second action plan.
(3): In the aspect of (1) above, the action plan generator outputs information indicating activation of the predetermined behavior control from the first action plan generator to the second action plan generator when the activation instruction of the predetermined behavior control is received during travel control by the second action plan.
(4): The aspect of (1) above further comprises: a first storage that stores a program for executing a function of the first action plan generator; and a second storage that stores a program for executing a function of the second action plan generator, wherein a program for generating an action plan that performs the predetermined behavior control is stored only in the first storage.
(5): In the aspect of (1) above, the action plan that performs the predetermined behavior control can be generated by the first action plan generator and cannot be generated by the second action plan generator.
(6): In the aspect of (1) above, the predetermined behavior control includes degenerate operation control of the vehicle in a case where the occupant is in a state not suitable for driving the vehicle.
(7): A travel control device according to one aspect of this invention comprises: a recognizer that recognizes a surrounding situation of a vehicle; a detector that detects at least one of a state of an occupant of the vehicle and an instruction operation by the occupant; an action plan generator that generates an action plan of the vehicle based on a recognition result by the recognizer and a detection result by the detector; and a travel controller that controls at least one of steering and speed of the vehicle to execute travel control of the vehicle based on the action plan generated by the action plan generator, wherein the travel controller comprises: a first travel controller that causes the vehicle to travel along a first action plan generated based on a preset rule; and a second travel controller that causes the vehicle to travel along a second action plan generated based on a model learned to generate an action plan based on external world information, the travel controller causes the first travel controller to execute travel control based on predetermined behavior control when an activation instruction of the predetermined behavior control is received during travel control by the first travel controller, and the travel controller switches from travel control by the second travel controller to travel control by the first travel controller to execute travel control based on the predetermined behavior control when the activation instruction of the predetermined behavior control is received during travel control by the second travel controller.
(8): In a travel control method according to one aspect of this invention, a computer recognizes a surrounding situation of a vehicle, detects at least one of a state of an occupant of the vehicle and an instruction operation by the occupant, generates an action plan of the vehicle based on a recognized result and a detected result, controls at least one of steering and speed of the vehicle to execute travel control of the vehicle based on the generated action plan, generates a first action plan based on a preset rule, generates a second action plan based on a model learned to generate an action plan based on external world information, causes predetermined behavior control for the vehicle to be executed in response to the state of the occupant or an operation instruction of the occupant even in a case where travel control of either the first action plan or the second action plan is being executed, causes the first action plan to execute travel control based on the predetermined behavior control when an activation instruction of the predetermined behavior control is received during travel control by the first action plan, and switches from travel control by the second action plan to travel control by the first action plan to execute travel control based on the predetermined behavior control when the activation instruction of the predetermined behavior control is received during travel control by the second action plan.
(9): A storage medium according to one aspect of this invention is a computer-readable non-transitory storage medium storing a program that causes a computer to: recognize a surrounding situation of a vehicle; detect at least one of a state of an occupant of the vehicle and an instruction operation by the occupant; generate an action plan of the vehicle based on a recognized result and a detected result; control at least one of steering and speed of the vehicle to execute travel control of the vehicle based on the generated action plan; generate a first action plan based on a preset rule; generate a second action plan based on a model learned to generate an action plan based on external world information; cause predetermined behavior control for the vehicle to be executed in response to the state of the occupant or an operation instruction of the occupant even in a case where travel control of either the first action plan or the second action plan is being executed; cause the first action plan to execute travel control based on the predetermined behavior control when an activation instruction of the predetermined behavior control is received during travel control by the first action plan; and switch from travel control by the second action plan to travel control by the first action plan to execute travel control based on the predetermined behavior control when the activation instruction of the predetermined behavior control is received during travel control by the second action plan.

According to the aspects of (1) to (9) above, more appropriate travel control can be executed even when the driver is in a state not suitable for driving.

### BRIEF DESCRIPTION OF THE DRAWINGS

FIG. 1 is a configuration diagram of a vehicle system using a travel control device according to an embodiment.

FIG. 2 is a functional configuration diagram of a first controller and a second controller.

FIG. 3 is a diagram showing an example of a functional configuration of an action plan generator of the embodiment.

FIG. 4 is a diagram showing an example of a target trajectory generated by the action plan generator.

FIG. 5 is a diagram for explaining stepwise switching of target trajectories.

FIG. 6 is a diagram showing an example of a configuration including two travel controllers.

FIG. 7 is a flowchart showing an example of a flow of processing executed by the automated driving control device of the embodiment.

### DESCRIPTION OF EMBODIMENTS

Hereinafter, embodiments of the travel control device, travel control method, and storage medium of the present invention will be described with reference to the drawings.

### Overall Configuration

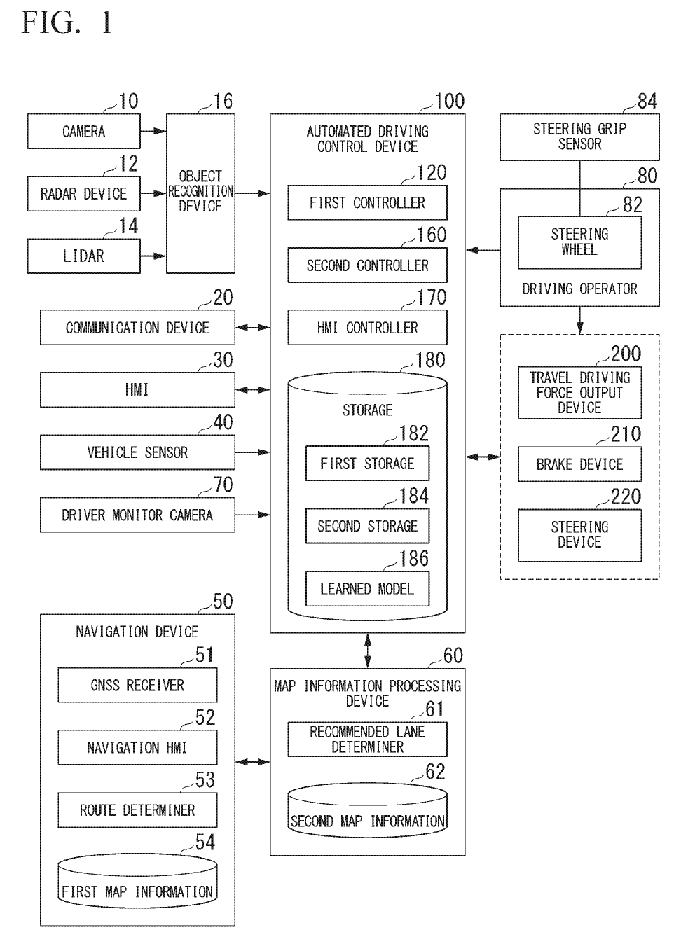

FIG. 1 is a configuration diagram of a vehicle system 1 using a travel control device according to an embodiment. A vehicle on which the vehicle system 1 is mounted is, for example, a two-wheeled, three-wheeled, four-wheeled, or other vehicle, and its drive source is an internal combustion engine such as a diesel engine or gasoline engine, an electric motor, or a combination thereof. The electric motor operates using electric power generated by a generator connected to the internal combustion engine, or discharge power of a secondary battery or fuel cell. Hereinafter, as an example, an embodiment in which the travel control device is applied to an automated driving vehicle will be described. Automated driving is, for example, automatically controlling at least one of steering and speed of a vehicle to execute travel control. The above-described travel control of the vehicle includes, for example, various travel controls such as ACC (Adaptive Cruise Control System), LKAS (Lane Keeping Assistance System), TJP (Traffic Jam Pilot), ALC (Auto Lane Changing), and CMBS (Collision Mitigation Brake System). Further, the travel control may include degenerate operation (MRM; Minimum Risk Maneuver) control that moves the vehicle M to a safe place (for example, a road shoulder or the like) and stops it. Further, the automated driving vehicle may be controlled by manual driving of an occupant (driver).

The vehicle system 1 comprises, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, a map information processing device 60, a driver monitor camera 70, a driving operator 80, an automated driving control device 100, a travel driving force output device 200, a brake device 210, and a steering device 220. These devices and equipment are connected to each other by a multiplex communication line such as a CAN (Controller Area Network) communication line, a serial communication line, a wireless communication network, or the like. Note that the configuration shown in FIG. 1 is merely an example, and a part of the configuration may be omitted, or another configuration may be added. The HMI 30 is an example of an "output unit". The automated driving control device 100 is an example of a "travel control device".

The camera 10 is, for example, a digital camera using a solid-state imaging element such as a CCD (Charge Coupled Device) or CMOS (Complementary Metal Oxide Semiconductor). The camera 10 is attached to an arbitrary location of a vehicle on which the vehicle system 1 is mounted (hereinafter, vehicle M). When imaging the front, the camera 10 is attached to an upper part of a front windshield, a back surface of a rearview mirror, or the like. The camera 10, for example, periodically and repeatedly images the surroundings of the vehicle M. The camera 10 may be a stereo camera.

The radar device 12 radiates radio waves such as millimeter waves to the surroundings of the vehicle M, and detects radio waves (reflected waves) reflected by an object to detect at least the position (distance and azimuth) of the object. The radar device 12 is attached to an arbitrary location of the vehicle M. The radar device 12 may detect the position and speed of an object by an FM-CW (Frequency Modulated Continuous Wave) method.

The LIDAR 14 irradiates light (or electromagnetic waves having a wavelength close to light) to the surroundings of the vehicle M and measures scattered light. The LIDAR 14 detects the distance to a target based on the time from light emission to light reception. The irradiated light is, for example, pulsed laser light. The LIDAR 14 is attached to an arbitrary location of the vehicle M.

The object recognition device 16 performs sensor fusion processing on detection results by some or all of the camera 10, the radar device 12, and the LIDAR 14, which are external world detectors, to recognize the position, type, speed, etc. of an object. The object recognition device 16 outputs a recognition result to the automated driving control device 100. The object recognition device 16 may output the detection result of the external world detector as it is to the automated driving control device 100. The object recognition device 16 may be omitted from the vehicle system 1. Further, the object recognition device 16 may be included in the external world detector.

The communication device 20 communicates with other vehicles existing around the vehicle M using a cellular network, Wi-Fi network, Bluetooth (registered trademark), DSRC (Dedicated Short Range Communication), or the like, or communicates with various server devices via a wireless base station.

The HMI 30 presents various information to occupants of the vehicle M under control of an HMI controller 170, and receives various input operations by the occupants. The HMI 30 includes, for example, various display devices, speakers, microphones, buzzers, touch panels, switches, keys, and the like. The switches include, for example, a turn signal switch (direction indicator). The HMI 30 receives, for example, instructions regarding start and end of automated driving, instructions to select types of driving modes, instructions to select any of a plurality of action plans described later, instructions regarding lighting of direction indicator lamps by the turn signal switch, and the like, and outputs the received operation instructions to the automated driving control device 100.

The vehicle sensor 40 includes a vehicle speed sensor that detects the speed of the vehicle M, an acceleration sensor that detects acceleration, a yaw rate sensor that detects angular velocity around a vertical axis, an azimuth sensor that detects the direction of the vehicle M, and the like.

The navigation device 50 comprises, for example, a GNSS (Global Navigation Satellite System) receiver 51, a navigation HMI 52, and a route determiner 53. The navigation device 50 holds first map information 54 in a storage device such as an HDD (Hard Disk Drive) or flash memory. The GNSS receiver 51 specifies the position of the vehicle M based on signals received from GNSS satellites. The position of the vehicle M may be specified or supplemented by an INS (Inertial Navigation System) using the output of the vehicle sensor 40. The navigation HMI 52 includes a display device, a speaker, a touch panel, keys, and the like. The navigation HMI 52 may be partially or entirely shared with the HMI 30 described above. The route determiner 53, for example, determines a route (hereinafter, a route on a map) from the position of the vehicle M specified by the GNSS receiver 51 (or an arbitrary input position) to a destination input by an occupant using the navigation HMI 52, with reference to the first map information 54. The first map information 54 is, for example, information in which road shapes are expressed by links indicating roads and nodes connected by the links. The first map information 54 may include road curvature, POI (Point Of Interest) information, and the like. The route on the map is output to the map information processing device 60. The navigation device 50 may perform route guidance using the navigation HMI 52 based on the route on the map. The navigation device 50 may be realized by, for example, functions of a terminal device such as a smartphone or tablet terminal held by an occupant. The navigation device 50 may transmit the current position and destination to a navigation server via the communication device 20 and acquire a route equivalent to the route on the map from the navigation server.

The map information processing device 60, for example, includes a recommended lane determiner 61 and holds second map information 62 in a storage device such as an HDD or flash memory. The recommended lane determiner 61 divides the route on the map provided from the navigation device 50 into a plurality of blocks (for example, divides every 100 [m] with respect to the vehicle traveling direction), and determines a recommended lane for each block with reference to the second map information 62. The recommended lane determiner 61 makes a determination such as traveling in which lane from the left. For example, when a branch point exists on the route on the map, the recommended lane determiner 61 determines a recommended lane so that the vehicle M can travel on a rational route for proceeding to the branch destination.

The second map information 62 is map information with higher accuracy than the first map information 54. The second map information 62 includes, for example, information on the center of a lane or information on lane boundaries. Further, the second map information 62 may include road information, traffic regulation information, address information (address/postal code), facility information, telephone number information, and the like. The second map information 62 may be updated at any time by the communication device 20 communicating with other devices. The first map information 54 and the second map information 62 may be provided integrally as map information. Further, at least one of the first map information 54 and the second map information 62 may be stored in the automated driving control device 100.

The driver monitor camera 70 is, for example, a digital camera using a solid-state imaging element such as a CCD or CMOS. The driver monitor camera 70 is attached to an arbitrary location on the vehicle M at a position and orientation capable of imaging the head of an occupant (hereinafter, driver) seated in the driver's seat of the vehicle M from the front (in a direction to image the face), for example. For example, the driver monitor camera 70 is attached to an upper part of a display device provided at a central part of an instrument panel of the vehicle M.

The driving operator 80 includes, for example, a steering wheel 82, as well as an accelerator pedal, a brake pedal, a shift lever, and other operators. A sensor that detects an operation amount or presence or absence of operation is attached to the driving operator 80, and the detection result is output to the automated driving control device 100, or some or all of the travel driving force output device 200, the brake device 210, and the steering device 220. The steering wheel 82 is an example of an "operator that receives a steering operation by a driver". The operator does not necessarily have to be circular, and may be in the form of a deformed steering wheel, a joystick, buttons, or the like. A steering grip sensor 84 is attached to the steering wheel 82. The steering grip sensor 84 is realized by, for example, a capacitance sensor or the like, and outputs to the automated driving control device 100 a signal capable of detecting whether or not the driver is gripping the steering wheel 82 (meaning being in contact in a state where force can be applied).

The automated driving control device 100 comprises, for example, a first controller 120, a second controller 160, an HMI controller 170, and a storage 180. The first controller 120, the second controller 160, and the HMI controller 170 are each realized by, for example, a hardware processor such as a CPU (Central Processing Unit) executing a program (software). Further, some or all of these components may be realized by hardware (including circuitry) such as an LSI (Large Scale Integration), ASIC (Application Specific Integrated Circuit), FPGA (Field-Programmable Gate Array), GPU (Graphics Processing Unit), or may be realized by cooperation between software and hardware. The program may be stored in advance in a storage device (a storage device including a non-transitory storage medium) such as an HDD or flash memory of the automated driving control device 100, or may be stored in a removable storage medium such as a DVD or CD-ROM, and installed in the HDD or flash memory of the automated driving control device 100 by mounting the storage medium (non-transitory storage medium) in a drive device. The second controller 160 is an example of a "travel controller". Further, the travel controller may include a part of the functions of the action plan generator 140. The HMI controller 170 is an example of an "output controller".

The storage 180 may be realized by the various storage devices described above, or an SSD (Solid State Drive), EEPROM (Electrically Erasable Programmable Read Only Memory), ROM (Read Only Memory), RAM (Random Access Memory), or the like. The storage 180 includes, for example, a first storage 182 and a second storage 184. Further, the storage 180 stores a learned model 186, information necessary for executing travel control in this embodiment, other various information, programs, and the like. Further, the storage 180 may store map information (for example, at least one of the first map information 54 and the second map information 62). Details of the first storage 182, the second storage 184, and the learned model 186 will be described later.

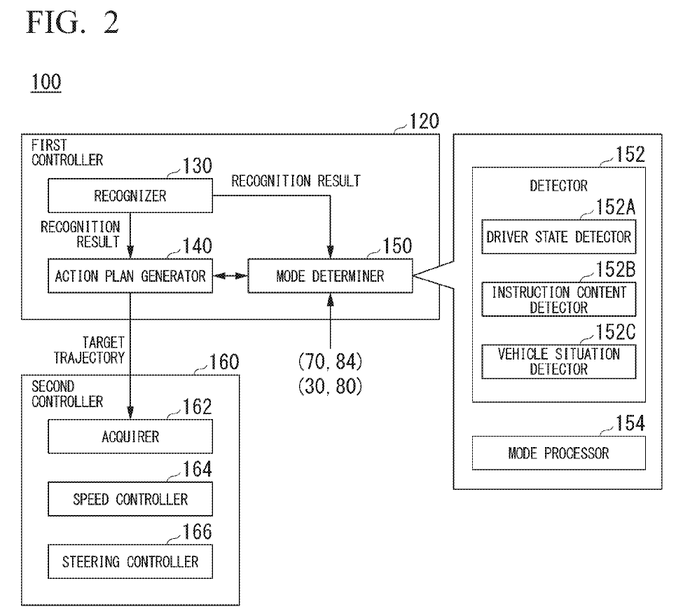

FIG. 2 is a functional configuration diagram of the first controller 120 and the second controller 160. The first controller 120 comprises, for example, a recognizer 130, an action plan generator 140, and a mode determiner 150. The first controller 120 is realized, for example, by executing in parallel or by executing one with priority a function based on a model given in advance and a function based on AI (Artificial Intelligence). For example, a function of "recognizing an intersection" may be realized by executing in parallel recognition based on a preset rule (there are signals, road markings, etc. that can be pattern-matched) and recognition of an intersection by machine learning (for example, Neural Network), and comprehensively evaluating by scoring both. This ensures reliability of automated driving.

The recognizer 130 recognizes the position, speed, acceleration, and other states of objects around the vehicle M based on information input from external world detectors (for example, the camera 10, radar device 12, and LIDAR 14) via the object recognition device 16. The position of an object is recognized as, for example, a position on absolute coordinates with the origin at a representative point (center of gravity, driving axle center, etc.) of the vehicle M, and used for control. The position of an object may be represented by a representative point such as the center of gravity or corner of the object, or may be represented by a region. The "state" of an object may include the acceleration or jerk of the object, or a "behavior state" (for example, whether or not a lane change is being made or is about to be made).

Further, the recognizer 130 recognizes, for example, a lane in which the vehicle M is traveling (traveling lane). For example, the recognizer 130 recognizes the traveling lane by comparing a pattern of road lane markings (for example, an arrangement of solid lines and broken lines) obtained from the second map information 62 with a pattern of road lane markings around the vehicle M recognized from an image captured by the camera 10. Note that the recognizer 130 may recognize the traveling lane by recognizing a road boundary (road boundary) including road lane markings, road shoulders, curbs, median strips, guardrails, and the like, not limited to road lane markings. In this recognition, the position of the vehicle M acquired from the navigation device 50 and the processing result by the INS may be taken into account. Further, the recognizer 130 recognizes stop lines, obstacles, red lights, toll gates, and other road events. Further, the recognizer 130 recognizes an adjacent lane adjacent to the traveling lane. The adjacent lane is, for example, a lane capable of proceeding in the same direction as the traveling lane.

When recognizing the traveling lane, the recognizer 130 recognizes the position and posture of the vehicle M with respect to the traveling lane. The recognizer 130 may recognize, for example, a deviation of a reference point of the vehicle M from the lane center, and an angle formed with respect to a line connecting the lane centers in the traveling direction of the vehicle M, as the relative position and posture of the vehicle M with respect to the traveling lane. Alternatively, the recognizer 130 may recognize the position of the reference point of the vehicle M with respect to either side end (road lane marking or road boundary) of the traveling lane as the relative position of the vehicle M with respect to the traveling lane. Here, the reference point of the vehicle M may be the center of the vehicle M or the center of gravity. Further, the reference point may be an end (front end, rear end) of the vehicle M, or may be a position where one of a plurality of wheels included in the vehicle M exists.

The action plan generator 140, for example, based on a recognition result by the recognizer 130, information acquired from the mode determiner 150, and the like, in principle travels in the recommended lane determined by the recommended lane determiner 61, and further automatically (without depending on the driver's operation) generates a target trajectory that the vehicle M will travel in the future so as to be able to cope with the surrounding situation of the vehicle M. The target trajectory includes, for example, a speed element. For example, the target trajectory is expressed as a sequence of points (trajectory points) that the vehicle M should reach. A trajectory point is a point that the vehicle M should reach at every predetermined travel distance (for example, about several [m]) along the road, and separately from this, a target speed and target acceleration at every predetermined sampling time (for example, about 0.X [sec]) are generated as part of the target trajectory. Further, a trajectory point may be a position that the vehicle M should reach at the sampling time at every predetermined sampling time. In this case, information on target speed and target acceleration is expressed by intervals between trajectory points.

Further, in the embodiment, the action plan generator 140 generates an action plan (first action plan) using a rule-based function given in advance as described above and an action plan (second action plan) using an AI-based function such as machine learning, and selects either action plan according to the surrounding situation of the vehicle M, the state of the driver, and the like. Here, generating an action plan means, for example, generating a future target trajectory of the vehicle M. Details of the above contents will be described later.

Note that the action plan generator 140 may activate an event (function) of automated driving when generating a target trajectory. Events of automated driving include a constant speed travel event, a low speed following travel event, a lane change event, a branch event, a merge event, a degenerate operation event, a takeover event, and the like. The action plan generator 140 generates a target trajectory according to the activated event.

The mode determiner 150, for example, based on at least one of a recognition result by the recognizer 130, an image captured by the driver monitor camera 70, a detection result by the steering grip sensor 84, information received by the HMI 30, and operation content of the driving operator 80, determines a driving mode of the vehicle M according to the surrounding situation of the vehicle M and the state of occupants of the vehicle M. For example, the mode determiner 150 determines the driving mode to be executed by the vehicle M to be any of a plurality of driving modes (in other words, a plurality of modes with different degrees of automation) with different tasks imposed on the driver, according to the situation of the vehicle M and the state of the driver.

Here, the driving modes in the embodiment include, for example, a first driving mode and a second driving mode in which the degree of driving assistance is lower than the first driving mode or the task of the driver of the vehicle M is greater than the first driving mode. A low degree of driving assistance means, for example, that the automation rate in travel control is low. A low automation rate means, for example, that the degree to which the automated driving control device 100 controls the steering or speed of the vehicle M is low (the degree to which the driver needs to intervene in steering or speed operation is high). A large task of the driver includes, for example, a large number of tasks imposed on the driver or severe tasks. A task is, for example, the driver monitoring the surroundings of the vehicle M, the driver operating the driving operator 80, and the like. Operation of the driving operator 80 includes, for example, the driver entering a state of gripping the steering wheel (hereinafter, hands-on state). Note that the driving modes may include a third driving mode or the like in which the degree of driving assistance is lower than the second driving mode or the task of the driver of the vehicle M is greater than the second driving mode. Further, the driving mode with the lowest degree of driving assistance or the largest task of the driver of the vehicle M may be a completely manual driving mode (a mode in which travel control is not executed).

For example, the first driving mode has no task for the driver (or is the lightest), and travel control (for example, ACC, LKAS, TJP, ALC, CMBS, etc.) in a state where the driver of the vehicle M is not gripping the steering wheel (hereinafter, hands-off state) is permitted. Further, in the second driving mode, the task imposed on the driver may include, for example, being in a hands-on state along with monitoring the surroundings of the vehicle M.

The mode determiner 150 outputs the determined mode to the action plan generator 140 and causes it to generate a target trajectory corresponding to the mode. The mode determiner 150 comprises, for example, a detector 152 and a mode processor 154. The detector 152 comprises, for example, a driver state detector 152A, an instruction content detector 152B, and a vehicle situation detector 152C.

The driver state detector 152A detects whether or not an occupant (driver) is in a state suitable for driving (which may be rephrased as whether or not the occupant is in an abnormal state). For example, the driver state detector 152A monitors the state of the driver for the mode change described above, and detects whether or not the state of the driver is a state corresponding to the task. For example, the driver state detector 152A performs known image analysis processing (for example, matching processing such as edge, shape, size, color feature extraction, pattern matching, etc.) on an image captured by the driver monitor camera 70, performs driver posture estimation processing from the analysis result, and determines whether or not the driver is in a posture capable of manual driving (for example, a posture capable of shifting to manual driving in response to a request from the system). Further, the driver state detector 152A may perform line-of-sight estimation processing from the analysis result of an image captured by the driver monitor camera 70, and determine whether or not the driver is monitoring the surroundings (more specifically, the front) of the vehicle M. Further, the driver state detector 152A may determine whether or not the driver is gripping the steering wheel 82 based on the detection result of the steering grip sensor 84. Based on these various determination results, when the driver state detector 152A determines that the state is not a state corresponding to the task for a predetermined time or longer, it detects that the driver is not in a state suitable for driving (the driver is in an abnormal state), and when it determines that the state is a state corresponding to the task for a predetermined time or longer, it detects that the driver is in a state suitable for driving (the driver is not in an abnormal state).

Further, the driver state detector 152A may detect that the driver is not in a state suitable for driving (the driver is in an abnormal state) when an expression of the driver from the analysis result of an image captured by the driver monitor camera 70 is an expression not suitable for driving such as a state of looking distressed or sleepy for a predetermined time or longer.

The instruction content detector 152B detects content of an operation instruction of the driver received from the HMI 30 or the like. The content of the operation instruction includes, for example, an instruction regarding start or end of automated driving, an instruction to select a type of travel control or driving mode, an instruction to select any of a plurality of action plans, and the like. Further, the content of the operation instruction may include an execution instruction of predetermined behavior control for the vehicle M. The predetermined behavior control for the vehicle M is, for example, degenerate operation (MRM) control, but is not limited thereto, and may be any control in which travel control such as specific steering or speed (specific function) is executed for the vehicle M under somewhat limited conditions or environments, such as automatic parking control. In the following description, as an example, it will be described assuming that the predetermined behavior control is degenerate operation control.

The vehicle situation detector 152C detects a traveling situation of the vehicle M. The traveling situation of the vehicle M includes, for example, a current driving mode of the vehicle M, a position and speed of the vehicle M on a road based on a recognition result of the recognizer 130. Further, the vehicle situation detector 152C may detect information regarding a road situation during travel (for example, road shape, presence or absence of other vehicles, number, position (relative position), speed (relative speed)) based on a recognition result of the recognizer 130, and may detect whether or not lane markings partitioning a lane (traveling lane) in which the vehicle M travels are recognized. Further, the vehicle situation detector 152C may detect that an adjacent lane adjacent to the traveling lane exists based on a recognition result of the recognizer 130.

The mode processor 154 determines a driving mode of the vehicle M based on at least one of respective determination results by the driver state detector 152A, the instruction content detector 152B, and the vehicle situation detector 152C, and performs various processing for change when a change of the driving mode is necessary.

For example, when a start instruction of the first driving mode is detected by the instruction content detector 152B during execution of the second driving mode of the vehicle M, the mode processor 154 determines whether or not the first driving mode is executable based on a determination result by the vehicle situation detector 152C, determines to switch to the first driving mode when it is determined that start is possible, and outputs switching to the first driving mode to the action plan generator 140.

Further, when an execution instruction of specific travel control (for example, LKAS, ALC, etc.) of the first driving mode is detected by the instruction content detector 152B during execution of the first driving mode, the mode processor 154 determines whether or not the surrounding situation of the vehicle M is a situation in which the instructed travel control can be executed, and determines to switch to the instructed travel control when it is determined that execution is possible. For example, when the instructed travel control is LKAS of the first driving mode, the mode processor 154 determines to execute LKAS when lane markings partitioning the traveling lane of the vehicle M are detected by the vehicle situation detector 152C, and outputs an execution instruction of LKAS to the action plan generator 140. Further, when the instructed travel control is ALC, the mode processor 154 determines to execute ALC when the traveling lane of the vehicle M and an adjacent lane of a lane change destination are detected by the vehicle situation detector 152C, and outputs an execution instruction of ALC to the action plan generator 140.

Further, when it is determined by the vehicle situation detector 152C that the first driving mode cannot be executed (continued) during execution of the first driving mode of the vehicle M, the mode processor 154 determines to execute the second driving mode (for example, manual driving). A situation in which the first driving mode cannot be executed is, for example, when lane markings of the traveling lane of the vehicle M can no longer be recognized during execution of ALC control or LKAS control, when it is not a travel section in which the first driving mode can be executed, when an abnormality occurs in at least a part of external world detectors (camera 10, radar device 12, LIDAR 14) of the vehicle M, or when recognition accuracy of surroundings by the recognizer 130 decreases due to the influence of weather such as heavy rain or snow accumulation.

When the mode processor 154 determines to switch from the first driving mode to the second driving mode, it causes the HMI controller 170 to control the HMI 30 to prompt the driver to execute a predetermined task for switching to the second driving mode. The predetermined task here is, for example, monitoring the surroundings of the vehicle M by the driver or gripping the steering wheel 82. For example, when it is determined by the driver state detector 152A that the driver is in a state suitable for driving, it determines to switch to the second driving mode and outputs switching to the second driving mode to the action plan generator 140.

Further, when a predetermined time has elapsed since information for prompting the driver to execute a predetermined task for switching to the second driving mode was output from the HMI 30 but the task has not been executed, or when it is determined by the driver state detector 152A that the driver is not in a state suitable for driving, the mode processor 154 determines to activate (execute) degenerate operation control such as moving the vehicle M to a road shoulder or the like regardless of the driver's operation and gradually stopping it, and stopping (ending) the first driving mode. An action plan generation instruction corresponding to the degenerate operation is output to the action plan generator 140. After automated driving is stopped, the vehicle M shifts to a driving mode with a low degree of automation, and it becomes possible to start the vehicle M by manual operation of the driver.

Further, when the instruction content determined by the instruction content detector 152B is switching to the second driving mode during execution of the first driving mode, the mode processor 154 similarly determines whether or not the driver is in a state suitable for driving in the second driving mode, and performs processing according to the determination result. Further, when it is determined that the driver is not in a state suitable for driving (the driver is abnormal) during execution of the first driving mode, the mode processor 154 may determine to activate (execute) the degenerate operation control described above and instruct the action plan generator 140 to that effect. Further, the mode processor 154 may output the state of the driver (for example, that the driver is not in a state suitable for driving the vehicle M) to the action plan generator 140.

The second controller 160 controls the travel driving force output device 200, the brake device 210, and the steering device 220 so that the vehicle M passes through the target trajectory (more specifically, the target trajectory selected from a plurality of action plans (target trajectories)) generated by the action plan generator 140 at a scheduled time.

The second controller 160 comprises, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the travel driving force output device 200 or the brake device 210 based on a speed element associated with the target trajectory stored in the memory. The steering controller 166 controls the steering device 220 according to the degree of bending of the target trajectory stored in the memory. Processing of the speed controller 164 and the steering controller 166 is realized by, for example, a combination of feedforward control and feedback control. As an example, the steering controller 166 executes a combination of feedforward control according to curvature of a road ahead of the vehicle M and feedback control based on deviation from the target trajectory.

The HMI controller 170 notifies occupants (including the driver) of the vehicle M of predetermined information by the HMI 30. The predetermined information includes, for example, information related to travel of the vehicle M such as information regarding the state of the vehicle M and information regarding travel control. Information regarding the state of the vehicle M includes, for example, speed of the vehicle M, engine speed, shift position, and the like. Further, information regarding travel control may include, for example, presence or absence of execution of automated driving, information regarding change of travel control or driving mode, information regarding a situation of travel control (for example, content of an event being executed) and a situation of a driving mode (driving mode being executed). Further, the predetermined information may include information not related to travel control of the vehicle M, such as television programs, content (for example, movies) stored in a storage medium such as a DVD. Further, the predetermined information may include, for example, information regarding a current position or destination of the vehicle M and a remaining amount of fuel.

For example, the HMI controller 170 may generate an image including the predetermined information described above and display the generated image on a display device of the HMI 30, and may generate voice indicating the predetermined information and output the generated voice from a speaker of the HMI 30. Further, the HMI controller 170 may output information received by the HMI 30 to the communication device 20, the navigation device 50, the first controller 120, and the like.

The travel driving force output device 200 outputs travel driving force (torque) for the vehicle to travel to drive wheels. The travel driving force output device 200 comprises, for example, a combination of an internal combustion engine, an electric motor, a transmission, and the like, and an ECU (Electronic Control Unit) that controls these. The ECU controls the above configuration according to information input from the second controller 160 or information input from the driving operator 80.

The brake device 210 comprises, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operator 80 so that brake torque according to a braking operation is output to each wheel. The brake device 210 may include as a backup a mechanism that transmits hydraulic pressure generated by operation of a brake pedal included in the driving operator 80 to the cylinder via a master cylinder. Note that the brake device 210 is not limited to the configuration described above, and may be an electronically controlled hydraulic brake device that controls an actuator according to information input from the second controller 160 to transmit hydraulic pressure of the master cylinder to the cylinder.

The steering device 220 comprises, for example, a steering ECU and an electric motor. The electric motor, for example, applies force to a rack and pinion mechanism to change the direction of steered wheels. The steering ECU drives the electric motor according to information input from the second controller 160 or information input from the steering wheel 82 of the driving operator 80 to change the direction of the steered wheels.

### Action Plan Generator

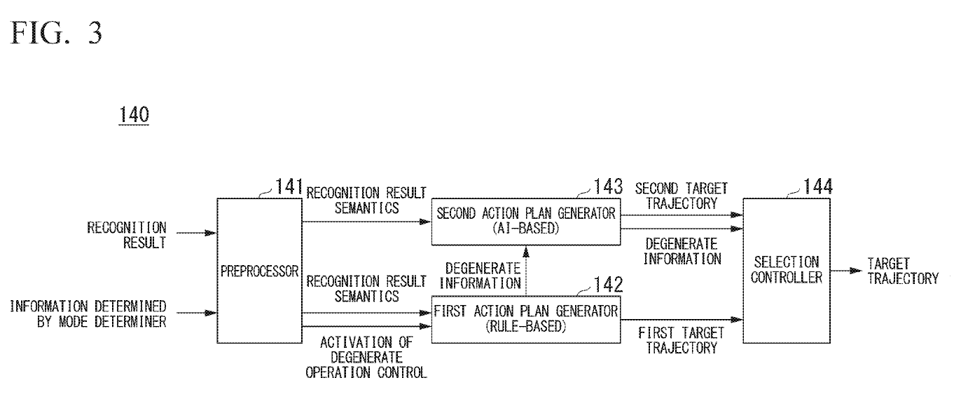

Hereinafter, processing of the action plan generator 140 will be specifically described. FIG. 3 is a diagram showing an example of a functional configuration of the action plan generator 140 of the embodiment. The action plan generator 140 comprises, for example, a preprocessor 141, a first action plan generator 142, a second action plan generator 143, and a selection controller 144.

The preprocessor 141, based on a recognition result of the recognizer 130 and information determined by the mode determiner 150, determines a rough policy of future behavior of the vehicle M, and sets semantics (target trajectory generation conditions) necessary for generating a target trajectory from that behavior. For example, when an execution instruction of LKAS control is received, target trajectory generation conditions (semantics) such that the vehicle travels in the center of the current traveling lane are set, and when an execution instruction of ALC control is received, target trajectory generation conditions (semantics) such that the vehicle changes lanes to a designated lane change destination lane are set. Further, the preprocessor 141 may predict future behavior of objects such as other vehicles existing around the vehicle M based on the recognition result. The preprocessor 141 outputs the setting result and prediction result described above and the recognition result by the recognizer 130 to the first action plan generator 142 and the second action plan generator 143.

Further, the preprocessor 141 may output an activation instruction of degenerate operation control to the first action plan generator 142 when an activation (execution) instruction of degenerate operation control is received by the mode determiner 150. Further, when an execution instruction of the second driving mode (for example, manual driving) is received by the mode determiner 150, the preprocessor 141 may output an instruction to end generation of an action plan (target trajectory) to the first action plan generator 142 and the second action plan generator 143. However, processing of generating action plans by the first action plan generator 142 and the second action plan generator 143 may be continued even during execution of manual driving. In this case, the selection controller 144 does not select either action plan.

Further, functions of the preprocessor 141 may be incorporated into each of the first action plan generator 142 and the second action plan generator 143, and in that case, the configuration of the preprocessor 141 may not be provided.

The first action plan generator 142 generates an action plan (first action plan) based on a preset rule (constraint conditions, etc.) based on information acquired from the preprocessor 141. For example, when LKAS or ALC by the first driving mode is instructed, the first action plan generator 142 generates a future target trajectory (first target trajectory) of the vehicle M on an optimization problem basis based on various constraint conditions based on rules so that the instructed driving mode and travel control can be achieved.

For example, when executing LKAS, the first action plan generator 142 generates an optimal first target trajectory (first vehicle trajectory) that satisfies the constraint conditions, with constraint conditions such as a reference point (for example, center of gravity or center of the vehicle M) of the vehicle M passing over the center of a lane partitioned by left and right lane markings, and traveling at a legal speed of the lane or a speed for not coming into contact with other vehicles existing in front and to the rear of the vehicle. An optimal target trajectory is, for example, a target trajectory with the smallest amount of change in behavior of the vehicle M, or a target trajectory with the lowest possibility of contact with obstacles such as other vehicles. Further, for example, when executing ALC, the first action plan generator 142 sets a target position of the vehicle M on a lane of a lane change destination (adjacent lane), and generates an optimal first target trajectory that satisfies the constraint conditions, with a constraint condition of moving to the target position within a predetermined time without contacting other vehicles around the vehicle M. In this way, the first action plan generator 142 generates a rule-based first target trajectory that satisfies and is optimal for each rule by comparing all information such as external world information (recognition result) with each rule (constraint condition) based on information acquired from the mode determiner 150.

Since the first target trajectory generated by the first action plan generator 142 generates a target trajectory based on predetermined rules, vehicle behavior tends to be stable, and smooth (sequential) behavior is possible particularly in lane changes and the like. However, in the first action plan generator 142, when the surroundings of the vehicle M are in a complex traffic environment, it may take time to find a solution that satisfies given constraint conditions, or there may be cases where a solution cannot be found, so there is a possibility that appropriate automated driving cannot be executed.

The second action plan generator 143 generates an action plan (second action plan) based on a model (learned model 186) learned to generate an action plan based on external world information (recognition result) or the like, based on information processed by the preprocessor 141. For example, when LKAS or ALC by the first driving mode is instructed, the second action plan generator 143 generates a target trajectory (second target trajectory) such that travel control corresponding to the instruction content is achieved on an inference basis (AI basis) based on the learned model 186. That is, the second action plan generator 143 generates a second action plan with logic different from that of generation of the first action plan by the first action plan generator 142.

For example, the second action plan generator 143 uses machine learning (for example, Neural-Network) or deep learning to learn in advance a model that takes external world information (for example, recognition result) and semantic information as input and outputs a second target trajectory inferred to be optimal, using teacher data (correct data) or past performance data. Then, the second action plan generator 143 acquires a second target trajectory inferred to be optimal by inputting information processed by the preprocessor 141 to the learned model 186 (inference device). Note that the learned model 186 may be acquired from an external device via the communication device 20, or may be learned by the second action plan generator 143. Further, the learned model 186 may be updated with data each time it is used by executing feedback control based on correct data.

Since the second action plan generator 143 can infer the environment globally (roughly) even in a complex traffic environment when generating the second target trajectory, the second target trajectory becomes a target trajectory according to a determined instruction even in a situation (surrounding situation) that has not been traveled in before. Therefore, automated driving can be continued without stopping the vehicle M. However, since the second target trajectory may easily output a completely different target trajectory if external world information changes even slightly, there is a possibility that the behavior of the vehicle M may not be stable.

The selection controller 144 selects either the first target trajectory (an example of the first action plan) generated by the first action plan generator 142 or the second target trajectory (an example of the second action plan) generated by the second action plan generator 143. For example, the selection controller 144 preferentially uses one of the two target trajectories (action plans) set in advance, and uses the other target trajectory when the one being used reaches a predetermined situation such as a performance limit. For example, when the learned model 186 is not yet mature immediately after shipment of the vehicle M or the like, the selection controller 144 selects the rule-based first target trajectory generated by the first action plan generator 142, and when the learned model 186 becomes mature (for example, when the vehicle M travels for a predetermined distance or longer or a predetermined time or longer and the learned model 186 is updated according to the travel result), the selection controller 144 may select the second target trajectory generated by the second action plan generator 143.

Further, the selection controller 144 may select a target trajectory corresponding to an instruction from the driver received by the HMI 30 from among the first target trajectory or the second target trajectory. This makes it possible to cause the vehicle M to travel on a target trajectory desired by the driver.

The acquirer 162 of the second controller 160 adjusts a control amount related to travel control of the vehicle M such as speed or steering based on the target trajectory selected by the selection controller 144, outputs the control amount for speed to the speed controller 164, and outputs the control amount for steering to the steering controller 166, thereby executing travel control according to the target trajectory. In this way, in the embodiment, by generating two types of target trajectories (action plans) by the action plan generator 140, it is possible to select a more appropriate target trajectory to cause the vehicle M to travel in correspondence with various travel scenes.

Here, as shown in FIG. 3, the action plan generator 140 executes degenerate operation control when there is an activation instruction of degenerate operation control based on the state of the driver (an example of an occupant) or an operation instruction of the driver for the vehicle M even in a case where the vehicle M is traveling with either the first target trajectory (an example of an action plan) or the second target trajectory (second action plan). In this case, when there is an activation instruction of degenerate operation control during travel control by the first target trajectory, the action plan generator 140 executes travel control based on the degenerate operation control by the first action plan generator 142. Further, when there is an activation instruction of degenerate operation control during travel control by the second target trajectory, the action plan generator 140 switches from travel control based on the second target trajectory generated by the second action plan generator 143 to travel control based on the first target trajectory generated by the first action plan generator 142, and executes travel control based on the first target trajectory for degenerate operation control.

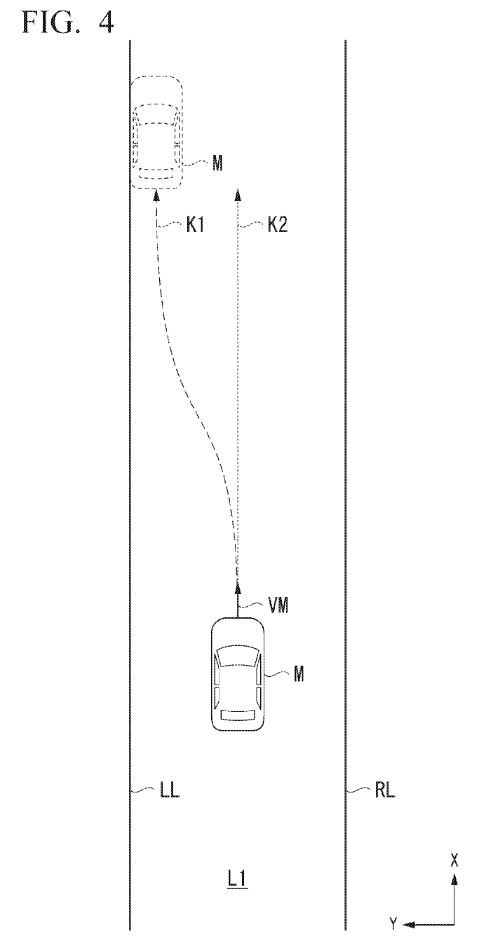

FIG. 4 is a diagram showing an example of a target trajectory generated by the action plan generator 140. In the example of FIG. 4, the vehicle M is traveling on a lane L1 partitioned by left and right lane markings LL and RL at a speed VM along an extending direction (X-axis direction in the figure) of the lane markings LL and RL. Further, in the example of FIG. 4, it is assumed that automated driving (LKAS) traveling in the center of the lane L1 along the second target trajectory K2 generated by the second action plan generator 143 is being executed.

In this situation, when the state of the driver (an example of an occupant) is not a state suitable for driving the vehicle M, or when an execution instruction of degenerate operation control (an example of predetermined behavior control) of the driver is received, the first action plan generator 142 generates a first target trajectory for executing degenerate operation control and outputs it to the selection controller 144. Then, the selection controller 144 selects the first target trajectory K1 from among the first target trajectory K1 and the second target trajectory K2, and executes travel control based on the first target trajectory K1.

Note that in the embodiment, when the state of the driver is not a state suitable for driving the vehicle M, or when an execution instruction of degenerate operation control of the driver is received, as shown in FIG. 3, the preprocessor 141 outputs activation of degenerate operation control to the first action plan generator 142. The first action plan generator 142 generates a first target trajectory for executing degenerate operation control and outputs it to the selection controller 144, and also outputs degenerate information, which is information indicating activation of degenerate operation control (information indicating that degenerate operation control will be executed), to the second action plan generator 143. This makes it possible to control the second action plan generator 143 on the first action plan generator 142 side that generates action plans premised on specific functions. The second action plan generator 143 generates a second target trajectory, and when degenerate information is input from the first action plan generator 142, outputs the degenerate information to the selection controller 144. The selection controller 144 selects the first target trajectory K1 based on the degenerate information obtained from the second action plan generator 143.

In this way, in the embodiment, when executing degenerate operation control in a situation where a plurality of target trajectories (action plans) exist, travel control is executed by always converging to the first target trajectory K1 generated by one action plan generator (first action plan generator 142) regardless of which target trajectory is being traveled on. For example, in control such as degenerate operation control that moves the vehicle M to a safe position such as a road shoulder of a traveling lane and stops it, since the behavior of the vehicle M is specified, it is better to control the vehicle M based on specific rules. Therefore, when the vehicle M is traveling based on the second target trajectory K2 of the second action plan generator 143, by performing stop control based on the first target trajectory K1 of the first action plan generator 142 suitable for degenerate operation control, it is possible to suppress variation in travel control in degenerate operation control and execute more appropriate travel control.

Further, since the second action plan generator 143 does not need to incorporate logic for generating a target trajectory premised on degenerate operation control, it is possible to suppress an increase in data volume of the learned model 186 of the second action plan generator 143. Note that in the embodiment, switching to the first action plan generator 142 is first, and mode change (switching from existing travel control (for example, LKAS control) to degenerate operation control) is not first.

Further, in the embodiment, rather than a redundant configuration of two action plan generators (first action plan generator 142, second action plan generator 143), even in a state where both can control normally, when activating predetermined behavior control according to the situation of the vehicle M, the state of the driver, or according to an operation instruction of the driver, switching is made to a target trajectory generated by an action plan generator that is good at that behavior control. Therefore, it is different from switching to the other due to failure of one action plan generator.

Further, when the first target trajectory and the second target trajectory are switched by the selection controller 144, if the difference between each target trajectory is large, the behavior of the vehicle M after switching may become large. In particular, when executing degenerate operation control as described above, as shown in FIG. 4, the difference between the first target trajectory K1 and the second target trajectory K2 becomes large. Therefore, when the selection controller 144 performs selection to switch the first target trajectory and the second target trajectory, it may adjust so that the target trajectory (action plan) before switching switches stepwise to the target trajectory (action plan) after switching, and execute travel control.

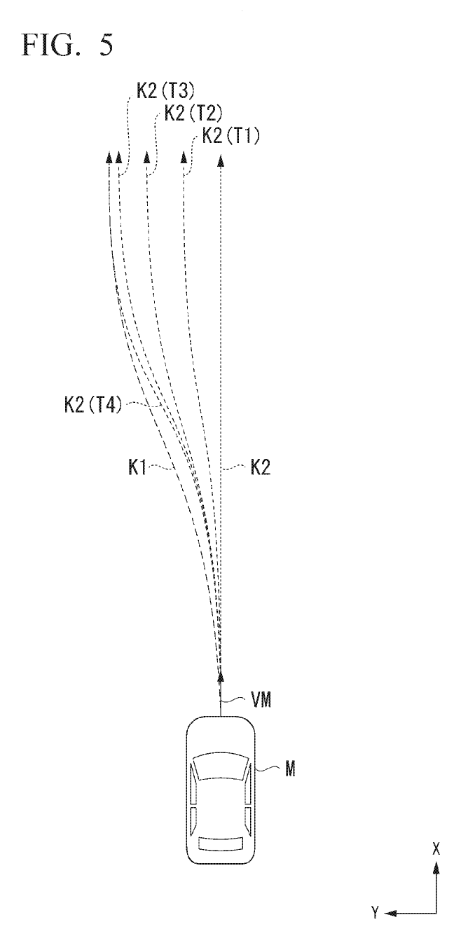

FIG. 5 is a diagram for explaining stepwise switching of target trajectories. In the example of FIG. 5, an example is shown in which switching is performed stepwise from the second target trajectory K2 during travel execution to the first target trajectory K1 in execution of the degenerate operation control described above. In the example of FIG. 5, a position of the second target trajectory K2 at time T* is expressed as K2(T*), and time T1 is the earliest, and time T2, T3, and T4 become later in order. When switching from the second target trajectory K2 to the first target trajectory K1, the selection controller 144 moves the second target trajectory K2 stepwise during a predetermined time as shown in FIG. 5, so that it overlaps with the first target trajectory K1 when time T4 is reached, and switches to the first target trajectory K1 when it overlaps. Note that when moving the second target trajectory K2 stepwise, in consideration of an equation of motion of the vehicle M set in advance, the second target trajectory K2 is gradually asymptoted to the position of the first target trajectory K1 so that an amount of change in behavior of the vehicle M is less than a predetermined amount.

In this way, by adjusting so that the second target trajectory K2 gradually becomes the first target trajectory K1, it is possible to stabilize the behavior of the vehicle M even when there is a difference between the first target trajectory K1 and the second target trajectory.

Note that, as described above, instead of bringing the second target trajectory K2 closer to the first target trajectory K1 for degenerate operation, the selection controller 144 may bring the second target trajectory K2 closer to the first target trajectory K1 before degenerate operation control, then switch to the first target trajectory K1, and generate the first target trajectory K1 for degenerate operation.

Further, in the embodiment, a program for generating the first target trajectory (a program for executing functions of the first action plan generator 142) is stored in the first storage 182, and a program for generating the second target trajectory (a program for executing functions of the second action plan generator 143) is stored in the second storage 184. The first storage 182 and the second storage 184 are different storage areas in the storage 180, but each may be a different storage. Further, in the embodiment, a program for generating a target trajectory corresponding to predetermined behavior control such as degenerate operation control may be stored only in the first storage 182. This makes it possible to suppress an increase in data capacity of the second storage 184 (second action plan generator 143), which originally has a larger data capacity than the first storage 182 (first action plan generator 142).

Further, in the embodiment, a target trajectory (action plan) corresponding to predetermined behavior control may be generated only by the first action plan generator 142 and may not be generated by the second action plan generator 143. This makes it possible to suppress degenerate operation control from being executable by each action plan generator, and to suppress large changes in behavior of the vehicle M during degenerate operation due to different target trajectories generated by a plurality of action plan generators.

Note that the predetermined behavior control described above includes degenerate control of the vehicle M in a case where the driver is in a state not suitable for driving (the driver is in an abnormal state), thereby making it possible to execute degenerate operation control by the rule-based first action plan generator 142 suitable for degenerate control when the driver is abnormal. Therefore, it is possible to suppress large changes according to surrounding situations and execute stable degenerate operation control.

According to the embodiment described above, more appropriate travel control can be executed even when the driver is in a state not suitable for driving.

### Modification

In the embodiment described above, the action plan generator 140 and the mode determiner 150 may be configured integrally. In this case, for example, the mode determiner 150 may be included in the action plan generator 140, or the action plan generator 140 may be included in the mode determiner 150. Further, in the above embodiment, switching of target trajectories (action plans) generated by two action plan generators was performed, but instead of this, two travel controllers (second controller 160) may be provided, and each travel controller may be switched and executed. At this time, a part of functions of the action plan generator 140 may be included in the travel controller.

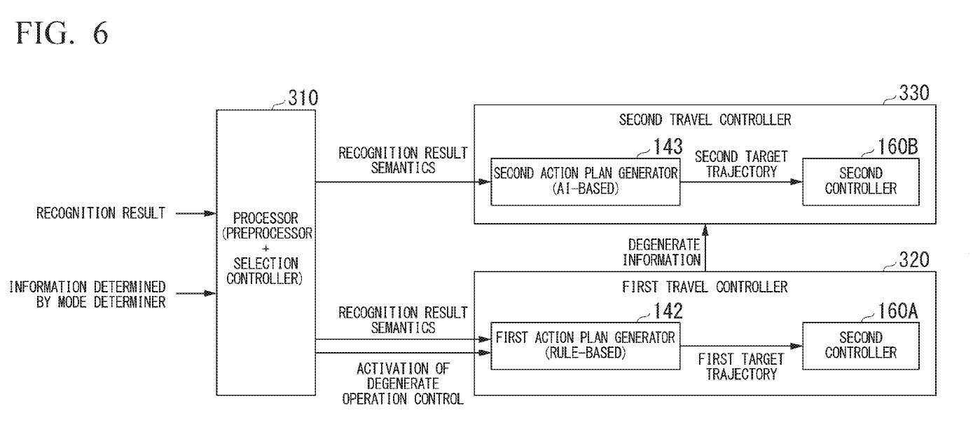

FIG. 6 is a diagram showing an example of a configuration including two travel controllers. In the configuration shown in FIG. 6, for example, a processor 310, a first travel controller 320, and a second travel controller 330 are provided instead of the action plan generator 140 and the second controller 160 described above. The first travel controller 320 comprises, for example, the first action plan generator 142 and a second controller 160A. The second travel controller 330 comprises, for example, the second action plan generator 143 and a second controller 160B. The second controller 160A and the second controller 160B are consistent in that both execute travel control of the vehicle M based on an input target trajectory.

The processor 310 has, for example, functions of the preprocessor 141 and the selection controller 144 described above. The first travel controller 320 controls at least one of steering and speed of the vehicle M to execute travel control of the vehicle M based on an action plan generated by the first action plan generator 142. Further, the first travel controller 320, for example, causes the vehicle M to travel along a first action plan (first target trajectory) generated based on a preset rule (constraint conditions, etc.). The second travel controller 330 controls at least one of steering and speed of the vehicle M to execute travel control of the vehicle M based on an action plan generated by the second action plan generator 143. Further, the second travel controller 330, for example, causes the vehicle M to travel along a second action plan (second target trajectory) generated based on a model (learned model 186) learned to generate an action plan based on external world information.

Here, based on information determined by the mode determiner 150, when activating predetermined behavior control such as degenerate operation control during travel control by the first travel controller 320, the processor 310 causes the first travel controller to execute the predetermined behavior control, and when activating the predetermined behavior control during travel control by the second travel controller 330, switches from travel control by the second travel controller 330 to travel control by the first travel controller 320 and executes travel control based on the predetermined behavior control. This switching control may be output from the processor 310 to the first travel controller 320 and the second travel controller 330, or the first travel controller 320 that has received an activation instruction of degenerate operation control may output degenerate information to the second travel controller 330 and control the second travel controller 330. This makes it possible to execute more appropriate travel control even when the driver is in a state not suitable for driving.

In the embodiment described above, the action plan generator 140 may include three or more different generators, and in the modification, the travel controller may include three or more different travel controllers.

### Processing Flow

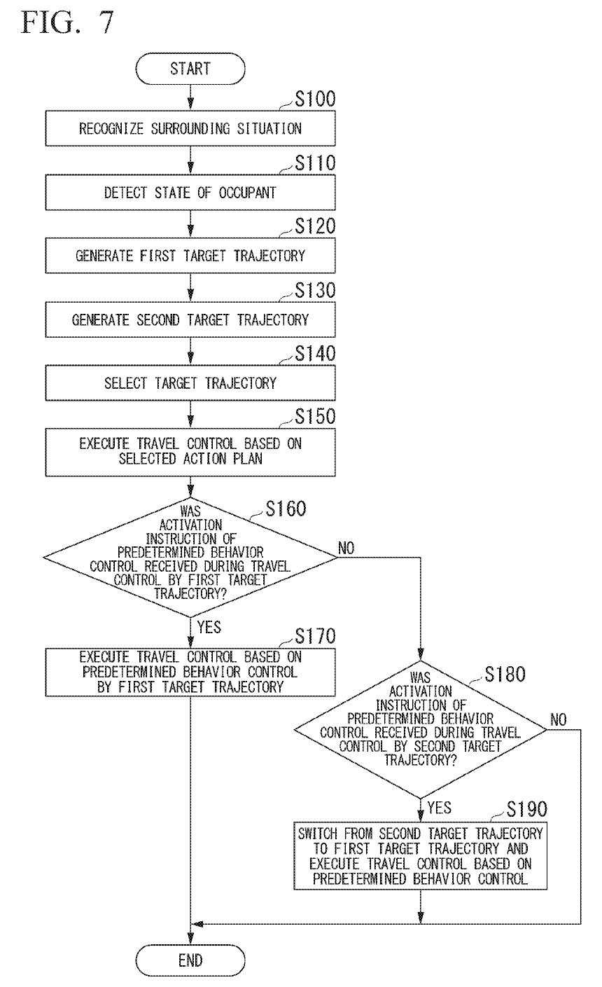

FIG. 7 is a flowchart showing an example of a flow of processing executed by the automated driving control device 100 of the embodiment. Note that in the example of FIG. 7, among processing executed by the automated driving control device 100, description will be given mainly focusing on travel control processing using a plurality of action plans. Further, processing shown in FIG. 7 may be repeatedly executed at a predetermined timing or a predetermined cycle, for example, during execution of automated driving or driving assistance.

In the example of FIG. 7, the recognizer 130 recognizes a surrounding situation of the vehicle M (step S100). Next, the driver state detector 152A detects a state of an occupant of the vehicle M (step S110). Next, the first action plan generator 142 generates a rule-based first target trajectory (an example of a first action plan) based on the surrounding situation of the vehicle M, the state of the occupant, and the like (step S120). Next, the second action plan generator 143 generates an AI-based second target trajectory (an example of a second action plan) using the learned model 186 based on the surrounding situation of the vehicle M, the state of the occupant, and the like (step S130). Note that processing of step S120 and step S130 may be executed in reverse order or may be executed in parallel.

Next, the selection controller 144 selects either the first target trajectory or the second target trajectory as a target trajectory based on a predetermined condition (step S140). The predetermined condition may be, for example, a priority order set in advance, or may be content specified by a user. Next, the travel controller (second controller 160) executes travel control based on the selected action plan (step S150).

Next, the selection controller 144 determines whether or not an activation instruction of predetermined behavior control has been received during travel control by the first target trajectory (step S160). When an activation instruction of predetermined behavior control is received, the selection controller 144 causes travel control based on the predetermined behavior control to be executed by the first target trajectory generated by the first action plan generator 142 (step S170). Further, in processing of step S160, when it is determined that an activation instruction of predetermined behavior control has not been received during travel control by the first target trajectory, the selection controller 144 determines whether or not an activation instruction of predetermined behavior control has been received during travel control by the second target trajectory (step S180). When it is determined that an activation instruction of predetermined behavior control has been received, the selection controller 144 switches from the second target trajectory of the second action plan generator 143 to the first target trajectory of the first action plan generator 142, and causes travel control based on the predetermined behavior control to be executed (step S190). This ends processing of this flowchart. Further, in processing of step S180, when it is determined that an activation instruction of predetermined behavior control has not been received during travel control by the second target trajectory, processing of this flowchart ends.

According to the embodiment described above, in the automated driving control device 100 (an example of a travel control device), a recognizer 130 that recognizes a surrounding situation of the vehicle M, a detector 152 that detects at least one of a state of an occupant of the vehicle M and an instruction operation by the occupant, an action plan generator 140 that generates an action plan of the vehicle M based on a recognition result by the recognizer 130 and a detection result by the detector 152, and a travel controller (second controller 160) that controls at least one of steering and speed of the vehicle M to execute travel control of the vehicle M based on an action plan generated by the action plan generator 140, are provided, the action plan generator 140 comprises a first action plan generator 142 that generates a first action plan based on a preset rule and a second action plan generator 143 that generates a second action plan based on a model learned to generate an action plan based on external world information, and the action plan generator 140 causes the travel controller to execute predetermined behavior control for the vehicle based on a state of the occupant or an operation instruction of the occupant even in a case where travel control of either the first action plan or the second action plan is being executed by the travel controller, causes the first action plan to execute travel control based on the predetermined behavior control when an activation instruction of the predetermined behavior control is received during travel control by the first action plan, and switches from travel control by the second action plan to travel control by the first action plan to execute travel control based on the predetermined behavior control when the activation instruction of the predetermined behavior control is received during travel control by the second action plan, whereby more appropriate travel control can be executed even when the driver is in a state not suitable for driving.

Specifically, according to the embodiment described above, among an AI-based action plan generator and a rule-based action plan generator, by providing a specific function such as degenerate operation control only in the rule-based action plan generator and selecting that action plan generator for execution of the specific function, travel control can be executed based on the rule-based action plan, so that execution of the specific function can be stabilized. Further, according to the embodiment, travel control can be executed based on the rule-based action plan when the driver is in a state not suitable for driving.

Further, when storing respective programs for executing functions of action plan generators in different storages, since a specific function such as degenerate operation control is not incorporated in a program for executing AI-based action plan generator functions, data capacity can be reduced.

Further, according to the embodiment, for example, in a case where the first action plan generator and the second action plan generator are managed by different control devicees, and driver abnormality control (degenerate operation control) is incorporated only on the first action plan generator side, when driver abnormality control is turned on during operation of travel control by the second action plan, it is possible to switch to the control device of the first action plan generator and perform driver abnormality control.

The embodiment described above can be expressed as follows.

A travel control device including: a storage medium storing computer-readable instructions, and

a processor connected to the storage medium,

wherein the processor executing the computer-readable instructions to:

recognize a surrounding situation of a vehicle;
detect at least one of a state of an occupant of the vehicle and an instruction operation by the occupant;
generate an action plan of the vehicle based on a recognized result and a detected result;
control at least one of steering and speed of the vehicle to execute travel control of the vehicle based on a generated action plan;
generate a first action plan based on a preset rule;
generate a second action plan based on a model learned to generate an action plan based on external world information;
cause predetermined behavior control for the vehicle to be executed in response to the state of the occupant or an operation instruction of the occupant even in a case where travel control of either the first action plan or the second action plan is being executed;
cause the first action plan to execute travel control based on the predetermined behavior control when an activation instruction of the predetermined behavior control is received during travel control by the first action plan; and
switch from travel control by the second action plan to travel control by the first action plan to execute travel control based on the predetermined behavior control when the activation instruction of the predetermined behavior control is received during travel control by the second action plan.

The embodiments for carrying out the present invention have been described above using the embodiments, but the present invention is not limited to such embodiments at all, and various modifications and substitutions can be added within a scope not departing from the gist of the present invention.

What is claimed is:

1. A travel control device comprising:
a recognizer that recognizes a surrounding situation of a vehicle;
a detector that detects at least one of a state of an occupant of the vehicle and an instruction operation by the occupant;
an action plan generator that generates an action plan of the vehicle based on a recognition result by the recognizer and a detection result by the detector; and
a travel controller that controls at least one of steering and speed of the vehicle to execute travel control of the vehicle based on the action plan generated by the action plan generator,
wherein the action plan generator comprises:
a first action plan generator that generates a first action plan based on a preset rule; and
a second action plan generator that generates a second action plan based on a model learned to generate an action plan based on external world information, and
the action plan generator
causes the travel controller to execute predetermined behavior control for the vehicle in response to the state of the occupant or an operation instruction of the occupant even in a case where travel control of either the first action plan or the second action plan is being executed by the travel controller,
causes the first action plan to execute travel control based on the predetermined behavior control when an activation instruction of the predetermined behavior control is received during travel control by the first action plan, and
switches from travel control by the second action plan to travel control by the first action plan to execute travel control based on the predetermined behavior control when the activation instruction of the predetermined behavior control is received during travel control by the second action plan.

2. The travel control device according to claim 1, wherein the action plan generator causes the travel controller to execute travel control by switching stepwise from the second action plan to the first action plan when the activation instruction of the predetermined behavior control is received during travel control by the second action plan.

3. The travel control device according to claim 1, wherein the action plan generator outputs information indicating activation of the predetermined behavior control from the first action plan generator to the second action plan generator when the activation instruction of the predetermined behavior control is received during travel control by the second action plan.

4. The travel control device according to claim 1, further comprising: a first storage that stores a program for executing a function of the first action plan generator; and
a second storage that stores a program for executing a function of the second action plan generator,
wherein a program for generating an action plan that performs the predetermined behavior control is stored only in the first storage.

5. The travel control device according to claim 1, wherein the action plan that performs the predetermined behavior control can be generated by the first action plan generator and cannot be generated by the second action plan generator.

6. The travel control device according to claim 1, wherein the predetermined behavior control includes degenerate operation control of the vehicle in a case where the occupant is in a state not suitable for driving the vehicle.

7. A travel control device comprising: a recognizer that recognizes a surrounding situation of a vehicle;
a detector that detects at least one of a state of an occupant of the vehicle and an instruction operation by the occupant;
an action plan generator that generates an action plan of the vehicle based on a recognition result by the recognizer and a detection result by the detector; and
a travel controller that controls at least one of steering and speed of the vehicle to execute travel control of the vehicle based on the action plan generated by the action plan generator,
wherein the travel controller comprises:
a first travel controller that causes the vehicle to travel along a first action plan generated based on a preset rule; and
a second travel controller that causes the vehicle to travel along a second action plan generated based on a model learned to generate an action plan based on external world information,
the travel controller causes the first travel controller to execute travel control based on predetermined behavior control when an activation instruction of the predetermined behavior control is received during travel control by the first travel controller, and
the travel controller switches from travel control by the second travel controller to travel control by the first travel controller to execute travel control based on the predetermined behavior control when the activation instruction of the predetermined behavior control is received during travel control by the second travel controller.

8. A travel control method in which a computer:
recognizes a surrounding situation of a vehicle;
detects at least one of a state of an occupant of the vehicle and an instruction operation by the occupant;
generates an action plan of the vehicle based on a recognized result and a detected result;
controls at least one of steering and speed of the vehicle to execute travel control of the vehicle based on a generated action plan;
generates a first action plan based on a preset rule;
generates a second action plan based on a model learned to generate an action plan based on external world information;
causes predetermined behavior control for the vehicle to be executed in response to the state of the occupant or an operation instruction of the occupant even in a case where travel control of either the first action plan or the second action plan is being executed;
causes the first action plan to execute travel control based on the predetermined behavior control when an activation instruction of the predetermined behavior control is received during travel control by the first action plan; and
switches from travel control by the second action plan to travel control by the first action plan to execute travel control based on the predetermined behavior control when the activation instruction of the predetermined behavior control is received during travel control by the second action plan.

9. A computer-readable non-transitory storage medium storing a program that causes a computer to:
recognize a surrounding situation of a vehicle;
detect at least one of a state of an occupant of the vehicle and an instruction operation by the occupant;
generate an action plan of the vehicle based on a recognized result and a detected result;
control at least one of steering and speed of the vehicle to execute travel control of the vehicle based on a generated action plan;
generate a first action plan based on a preset rule;
generate a second action plan based on a model learned to generate an action plan based on external world information;
cause predetermined behavior control for the vehicle to be executed in response to the state of the occupant or an operation instruction of the occupant even in a case where travel control of either the first action plan or the second action plan is being executed;
cause the first action plan to execute travel control based on the predetermined behavior control when an activation instruction of the predetermined behavior control is received during travel control by the first action plan; and
switch from travel control by the second action plan to travel control by the first action plan to execute travel control based on the predetermined behavior control when the activation instruction of the predetermined behavior control is received during travel control by the second action plan.
